(19) United States
(12) Patent Application Publication
(10) Pub. No.: US 2004/0181536 A1
(43) Pub. Date: Sep. 16, 2004

(54) Information providing method, provided information recording apparatus, provided information reading apparatus, and cooking-related device

(76) Inventors: Satoshi Matsuura, Kyoto (JP); Takahiro Kudo, Osaka (JP); Jun Ozawa, Nara (JP); Masaaki Sano, Kyoto (JP)

Correspondence Address: HARNESS, DICKEY & PIERCE, P.L.C., P.O. BOX 828, BLOOMFIELD HILLS, MI, 48303, US

(21) Appl. No.: 10/479,020

(22) PCT Filed: May 31, 2002
(86) PCT No.: PCT/JP02/05336

(30) Foreign Application Priority Data
May 31, 2001 (JP) 2001-165149

(51) Int. Cl. G06F 17/00

(52) U.S. Cl. 707/100

(57) ABSTRACT

For the purpose of making it easy to use contents composed of a plurality of files, provided are the steps of: concatenating a plurality of files constituting contents to form a concatenated file; creating a list including information representing the beginnings of the respective files in the concatenated file and adding the list to the concatenated file; storing the concatenated file to which the list has been added in a server; and downloading the concatenated file from the server via a communication network and storing the downloaded concatenated file on a recording medium.

### TECHNICAL FIELD

The present invention relates to a technology for utilizing information (contents) provided via a network or the like.

### BACKGROUND ART

In recent years, with the rapid spread and advances of the Internet, services of transmitting various kinds of information such as cooking data representing a cooking procedure (e.g., a recipe) to users have been provided in a variety of forms. In the case of transmission of such information, information containing a group of subjects (contents) is normally composed of a plurality of files including files described by markup languages such as a hypertext markup language (HTML) and image files.

Users of such information can make the contents, which are composed of the files, directly displayed on a screen of a terminal or displayed on a display section of another device via a recording medium such as a semiconductor memory card, using a browser program. As said another device, a mobile information terminal such as a cellular phone or a cooking apparatus having a function of displaying a cooking procedure is sometimes used. Since these devices generally have a small screen size of the display section or a small capacity of the memory usable for operating the browser, contents which are expected to be displayed by these devices are often composed of files having a relatively small size.

However, in a case where such files with a small size are recorded on a recording medium, the recording capacity is wasted, and there arises a problem that it is difficult to record a lot of contents. Specifically, files are stored on a recording medium such as a semiconductor memory card, taking a cluster having a given size as one unit, so that even files having a smaller size than the cluster size occupy the same capacity as the cluster size. Therefore, if a large number of small-size files are stored, a needless space which is not used increases. Accordingly, regardless of the presence of the space in which effective data is not actually recorded, a large number of files cannot be recorded, so that the capacity of the recording medium is not fully used.

Such a problem above is noticeable especially in a case where the contents are cooking data for displaying a cooking procedure and the like with a cooking apparatus or the like, for example. This is because contents of this type are often composed of files with a small size as described above, whereas cooking menus are decided for every meal every day and new recipes are provided frequently, so that it is desired that recipes are stored as many as possible. In addition, users of such contents are amateurs who do not have a concern about management of recoded data in most cases. Thus, a situation in which data cannot be newly recoded because the recorded data exceeds the recording capacity might give an impression of being nearly a failure of the apparatus. In view of this, it is also required to make full use of the capacity of the recording medium.

Further, if contents having a group of subjects are composed of a plurality of files, operation is required for every file in downloading, and thus the operation becomes complicated.

### DISCLOSURE OF INVENTION

The present invention therefore has a purpose of making it easy to effectively use contents composed of a plurality of files with a relatively small size.

To solve the problems described above, a solution offered by the invention of claim 1 is a content providing method including the steps of: creating a concatenated file by concatenating a plurality of files constituting contents; creating a list including information representing the beginnings of the respective files in the concatenated file and adding the list to the concatenated file; storing the concatenated file to which the list has been added in a server; and downloading the concatenated file from the server via a communication network and storing the downloaded concatenated file on a recording medium.

The invention of claim 2 is the content providing method of claim 1 characterized in that the concatenated file is stored on the recording medium by a given recording capacity unit.

The invention of claim 3 is the content providing method of claim 1 characterized by including the step of reading and displaying a file to be displayed in the concatenated file, based on the list.

The invention of claim 4 is the content providing method of claim 1 characterized in that the contents are information regarding cooking.

With these methods, contents composed of a plurality of files can be dealt with as one file. Accordingly, the recording capacity of a recording medium can be effectively used and the contents are easily managed by both a provider of the contents and a user of the contents. The use of such a concatenated file is effective especially for information regarding cooking which often includes a large number of files with a relatively small size.

It is herein assumed that the information regarding cooking includes recipe contents regarding cooking ingredients and a cooking procedure and cooking-apparatus controlling data.

The invention of claim 5 is a content providing method including the steps of: creating a concatenated file by concatenating a plurality of files constituting contents; creating a list including information representing the beginnings of the respective files in the concatenated file, and adding the list to the concatenated file; storing the concatenated file to which the list has been added in a server; and downloading the concatenated file from the server via a communication network, and displaying the downloaded concatenated file.

The invention of claim 6 is a content reading apparatus for reading a file from a concatenated file in which a plurality of files are concatenated, wherein the plurality of files constitute contents, the concatenated file is provided with a list including information representing the beginnings of the respective files in the concatenated file, and the beginning of a file to be read out is obtained by referring to the list, and the file to be read out is read out from the beginning.

The invention of claim 7 is the content reading apparatus of claim 6 characterized in that the file which has been read out is displayed on a display section.

The invention of claim 8 is the content information reading apparatus of claim 6, characterized in that the contents are information regarding cooking.

With these apparatuses, it is possible to deal with contents composed of a plurality of files as one file, so that the contents are managed easily by a content provider. Even if resources such as a memory of apparatus using the content are limited, a file to be read out can be read out easily.

The invention of claim 9 is a cooking-related apparatus for reading a concatenated file which is stored on a recording medium and in which a plurality of files constituting contents as information representing a cooking procedure are concatenated, wherein the concatenated file is provided with a list including information representing the beginnings of the respective files in the concatenated file, and the beginning of a file to be read out is obtained by referring to the list, and the file to be read out is read out from the beginning.

The invention of claim 10 is the cooking-related apparatus of claim 9 characterized in that the file which has been read out is displayed on a display section.

The invention of claim 11 is the cooking-related apparatus of claim 9 characterized in that the contents includes a file representing control information for controlling operation of the cooking-related apparatus, and the operation is controlled based on the control information.

With the cooking-related apparatus as described above, it is possible to cook while displaying the kind of menu, a cooking procedure and the like, easily. Since such information regarding cooking is composed of many files with a relatively small size in most cases, the use of the concatenated file as described above is effective. Examples of the cooking-related apparatus include a mobile terminal capable of displaying a cooking procedure and the like as described above and a so-called information viewer, as well as cooking apparatuses such as a microwave oven and an oven.

The invention of claim 12 is a content recording apparatus for recording, on a recording medium, contents downloaded from a server, wherein the contents are recorded on the recording medium by a given recording capacity unit, and a plurality of files constituting the contents are concatenated to create a concatenated file composed of combinations of the files such that each of the combinations has a size which is less than or equal to an integral multiple of the recording capacity unit and has a minimum difference from the integral multiple of the recording capacity unit.

The invention of claim 13 is the content recording apparatus of claim 12 characterized in that the recording capacity unit in the recording medium is detected, and the concatenated file is created based on a result of the detection.

With these apparatuses, contents are recorded as files having file sizes according to a recording capacity unit of a recording medium, so that the recording capacity of the recording medium is effectively used easily.

The invention of claim 14 is a content recording apparatus for recording, on a recording medium, contents downloaded from a server, wherein the contents are recorded on the recording medium by a given recording capacity unit, and a multiplex concatenated file is created by performing a multiplexing concatenation on a plurality of concatenated files which has been downloaded from the server and in which a plurality of files constituting the contents are concatenated, and the multiplex concatenated file is recorded on the recording medium.

The invention of claim 15 is the content recording apparatus of claim 14 characterized in that in performing the multiplexing concatenation, a list which is added to each of the concatenated files and which includes information representing the beginnings of the respective files in the concatenated files is removed, and a list including information representing the beginnings of the respective files and also representing a correlation between the files and the concatenated files in the multiplex concatenated file is created, and the list is added to the multiplex concatenated file, so that the multiplex concatenated file is created and recorded on the recording medium.

The invention of claim 16 is the content recording apparatus of claim 14 characterized in that in performing the multiplexing concatenation, the multiplexing concatenation is performed with a list including information representing the beginnings of the respective files in each of the concatenated files added to each of the concatenated files, and a list including information representing the beginnings of the respective concatenated files before the multiplexing concatenation in the multiplex concatenated file is created and added to the multiplex concatenated file, so that the multiplex concatenated file is created and recorded on the recording medium.

The invention of claim 17 is a content reading apparatus for reading a file recorded by the content recording apparatus of claim 14, wherein the beginning of a file before the first concatenation is performed included in the multiplex concatenated file is obtained, so that the file before the first concatenation is performed is read out.

The invention of claim 18 is a content reading apparatus for reading a file recorded by the content recording apparatus of claim 15, wherein the beginning of a file before the first concatenation is performed included in the multiplex concatenated file is obtained by referring to the list, so that the file before the first concatenation is performed is read out.

The invention of claim 19 is a content reading apparatus for reading a file recorded by the content recording apparatus of claim 16, wherein the beginning of a file before the first concatenation is performed included in the multiplex concatenated file is obtained by referring to the list, so that the file before the first concatenation is performed is read out.

With these apparatuses, the size of a concatenated file (multiplex concatenated file) can be changed flexibly with ease, so that the recording capacity of a recording medium is more effectively used with ease.

### BRIEF DESCRIPTION OF DRAWINGS

FIG. 1 is a schematic view showing an entire configuration of an information communication system according to an embodiment of the present invention.

FIG. 2 is a block diagram showing a configuration of a terminal 103 and other component according to the embodiment of the present invention.

FIG. 3 is a block diagram showing a configuration of a microwave oven 105 according to the embodiment of the present invention.

FIG. 4 is an illustration showing an example of contents according to the embodiment of the present invention.

FIG. 5 is an illustration showing a structure of a concatenated file according to the embodiment of the present invention.

FIG. 6 is an illustration showing a data storage structure in a semiconductor memory card 104 according to the embodiment of the present invention.

FIG. 7 is a flowchart showing a process of creating a concatenated file according to the embodiment of the present invention.

FIG. 8 is a flowchart showing a process for display according to the embodiment of the present invention.

FIG. 9 is an illustration showing a structure of concatenated files according to the embodiment of the present invention.

FIG. 10 is an illustration showing a structure of concatenated files which are double-concatenated according to the embodiment of the present invention.

FIG. 11 is an illustration showing another structure of concatenated files which are double-concatenated according to the embodiment of the present invention.

### BEST MODE FOR CARRYING OUT THE INVENTION

Hereinafter, an example of provision of cooking data representing a cooking procedure (e.g., a recipe) and the like will be described as an embodiment of the present invention with reference to the drawings.

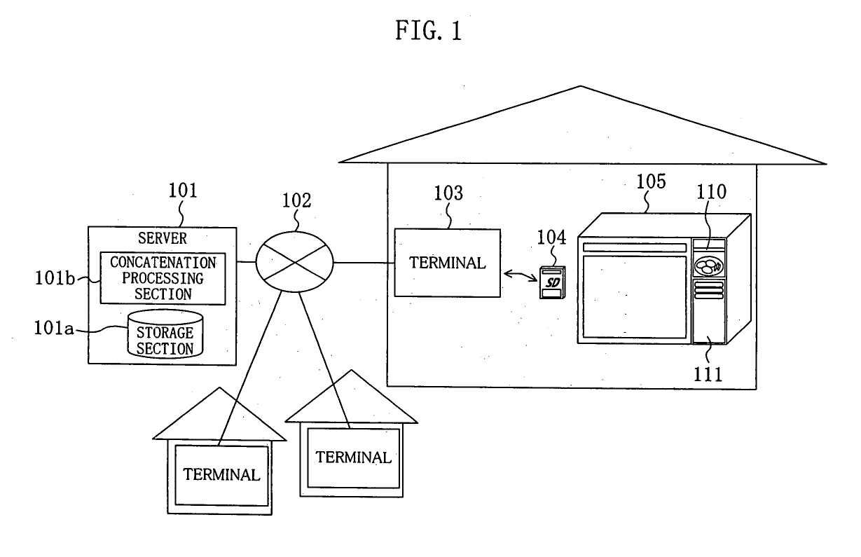

FIG. 1 is a schematic view showing an entire configuration of an information communication system according to an embodiment of the present invention. In the information communication system shown in FIG. 1, a content providing method according to the embodiment is performed. The information communication system shown in FIG. 1 includes: a server 101 responsible for services such as provision of cooking data; a communication network 102 typified by the Internet; a terminal 103 having a function as a content recording device; a semiconductor memory card 104 such as an SD card as a recording medium; and a microwave oven 105 having functions as a content reading apparatus and a cooking apparatus.

The server 101 is used for operations including transmission of cooking data using, for example, a hypertext transfer protocol (HTTP). The server 101 is configured as general servers including a storage section 101a such as a magnetic disk, but is different from the general servers in that the server 101 includes a concatenation processing section 101b and has a function of generating a concatenated file by concatenating a plurality of files as will be described later.

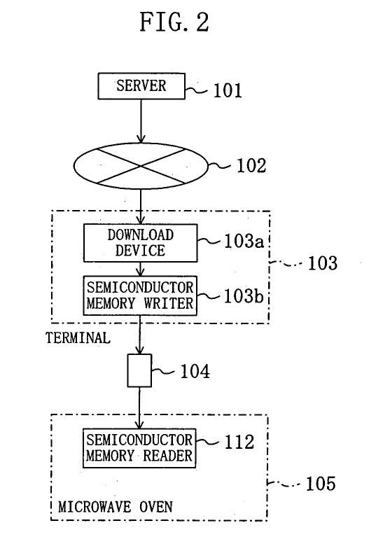

The terminal 103 includes: a download device 103a for receiving cooking data transmitted from the server 101; and a semiconductor memory writer 103b for recording the received cooking data on the semiconductor memory card 104, as shown in FIG. 2, for example. The terminal 103 is implementable by a personal computer, a cellular phone, a personal data assistant, a so-called set-top box, or like devices to which the semiconductor memory writer 103b, for example, is connected.

The semiconductor memory card 104 transfers the cooking data received and recorded by the terminal 103 to the microwave oven 105.

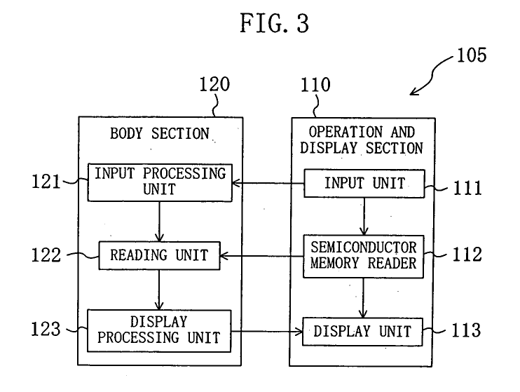

The microwave oven 105 includes: a body section 120; and an operation and display section 110 detachable, for example, from the body section 120, as specifically shown in FIG. 3, for example. The operation and display section 110 includes: an input unit 111 for instructing operation, display and other operations of the microwave oven 105; a semiconductor memory reader 112 for reading data recorded on the semiconductor memory card 104; and a display unit 113 using, for example, a liquid crystal display panel. The body section 120 includes: an input processing unit 121 for receiving the operation at the input unit 111; a reading unit 122 for controlling the semiconductor memory reader 112; and a display processing unit 123 for controlling the display unit 113. The microwave oven 105 further includes a heating section for heating, which is an essential function of the microwave oven 105, and a heating control section as well as the sections described above, and the description thereof will be herein omitted.

Now, an example of the contents of cooking data provided by the server 101 (contents) will be described.

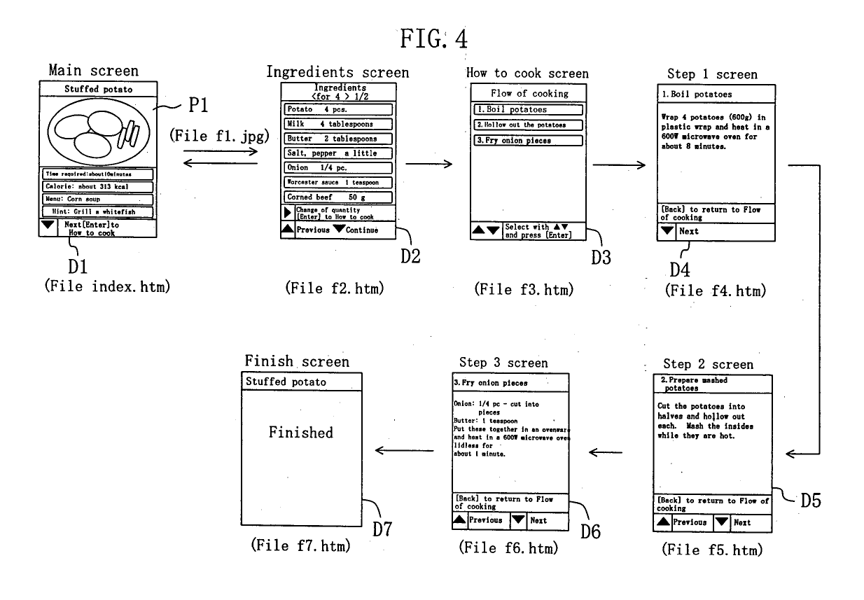

FIG. 4 is an illustration showing a transition of a display example on the display unit 113 according to the cooking data. In the example shown in FIG. 4, a recipe for cooking a dish, “Stuffed potato” is displayed. The cooking data for the display is composed of document files (HTML documents) for displaying a cooking procedure, ingredients and their quantities required, and the like on a screen, image files including a completion image of the recipe and an image for a cooking advice, control data files regarding temperature settings or heating power of a cooking apparatus during cooking, and other files. More specifically, in FIG. 4, a first display D1 shows an outline of the dish and includes an image P1. The display D1 is produced using a file index.htm for displaying portions other than the image P1 and a file f1.jpg linked to the file index.htm and used for displaying the image P1. A display D2 shows ingredients and is produced using a file f2.htm. In the same manner, displays D3 through D6 show a cooking procedure and are produced using files f3.htm, f4.htm, f5htm and f6.htm, respectively. A display D7 indicates completion of the dish and is produced using a file f7.htm.

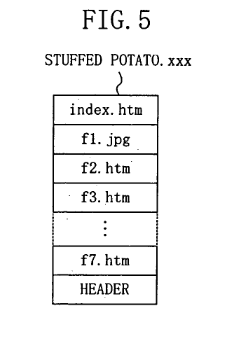

The files index.htm, f1.jpg, f2.htm through f7.htm are not recorded individually on the semiconductor memory card 104 but recorded as one concatenated file as shown in FIG. 5. That is to say, respective contents of the files are concatenated without being compressed and a header is finally added thereto, thereby forming one concatenated file. Specifically, the header contains file names of the respective files and information (offset) representing the beginning of the contents of the respective files in the concatenated file. The concatenated file is provided with a name, e.g., “stuffed potato.xxx” as a file name. Operations such as downloading, writing into the semiconductor memory card 104, and removal are performed with the concatenated file taken as one unit. A non-compressed zip format, for example, is applicable as a format of such a concatenated file. The files may be compressed when concatenated. However, if the files are not compressed, operation for expanding the files into original data is unnecessary in reading the contents of the files. Therefore, the non-compressed files are suitable especially for cases where the contents are read out and displayed, for example, with a device having a relatively low operation power such as the microwave oven 105 and a cellular phone or a device having small resources such as a memory capacity.

The order of concatenation of the files may correspond to the order of being used for display or the like, for example, but this correspondence is not necessary. That is to say, since any of the files can be read out immediately by providing the header as described above, the files may be stored in the concatenated file in any order.

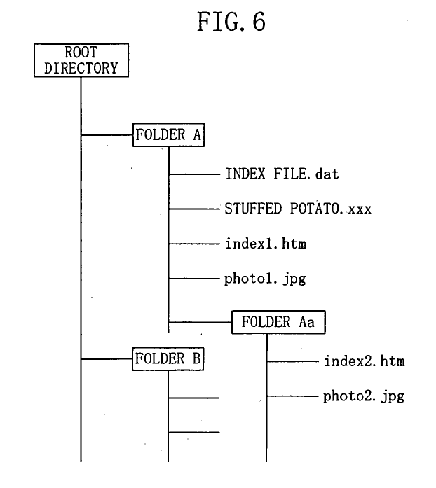

The recording structure in the case of recording the concatenated file on the semiconductor memory card 104 is not specifically limited, and may be recorded in a hierarchical structure as shown in FIG. 6, for example. Specifically, in the example shown in FIG. 6, folders A, B, . . . are provided in a root directory of the semiconductor memory card 104, and the concatenated file “stuffed potato.xxx” is recorded in the folder A. As shown in FIG. 6, normal files such as index1.htm and photo1.jpg which are not concatenated may be mixed or a folder Aa including normal files index2.htm and photo2.jpg and other files may be mixed. In addition, for the purpose of easily displaying a list of recipes recorded on the semiconductor memory card 104, files containing management information such as “index file.dat” may be additionally recorded.

In this manner, a plurality of files are thus concatenated to be recorded on the semiconductor memory card 104 as one concatenated file, so that the unnecessary available space is reduced for effective recording. Specifically, suppose a 32-Mbyte recording space of the semiconductor memory card 104 is managed by an 8-Kbyte cluster unit, for example, if two 1-Kbyte document files and a 5-Kbyte image file are recorded as respective single files, these single files occupy respective clusters, resulting in consuming 24-Kbyte recording space in total. On the other hand, if the concatenation as described above is performed, the size of the concatenated file is about 7 Kbytes, so that only one 8-Kbyte cluster is consumed. That is to say, as the total capacity of the semiconductor memory card 104 increases, the effect of reducing the unnecessary available space as described above is more remarkable because the cluster size generally increases.

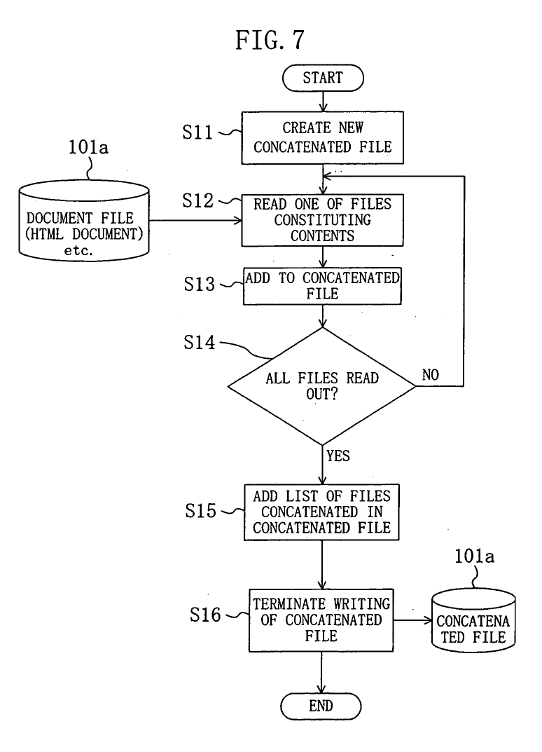

Next, a procedure of creating the concatenated file as described above in the server 101 will be described based on a flowchart shown in FIG. 7.

(Step S11) When an operator, for example, instructs creation of a concatenated file and specifies files to be included in the concatenated file (document files such as the files index.htm and f2.htm and image files such as the file f1.jpg created and stored in the storage section 101a beforehand: hereinafter referred to as subconcatenation files), a new concatenated file is created (opened for writing).

(Step S12) One of the subconcatenation files is read out from the storage section.

(Step S13) The file which has been read out is added to (written into) the concatenated file.

(Step S14) It is determined whether or not all the subconcatenation files are read out. If all the subconcatenation files are not read out, the process returns to (Step S12) and (Steps S12 through S14) are repeated. On the other hand, if all the subconcatenation files are read out, the process proceeds to (Step S15).

(Step S15) A list of the subconcatenation files is created and added to the concatenated file as a header as shown in FIG. 5.

(Step S16) The writing of the concatenated file is terminated (file is closed), and the storage of the concatenated file in the storage section 101a is completed.

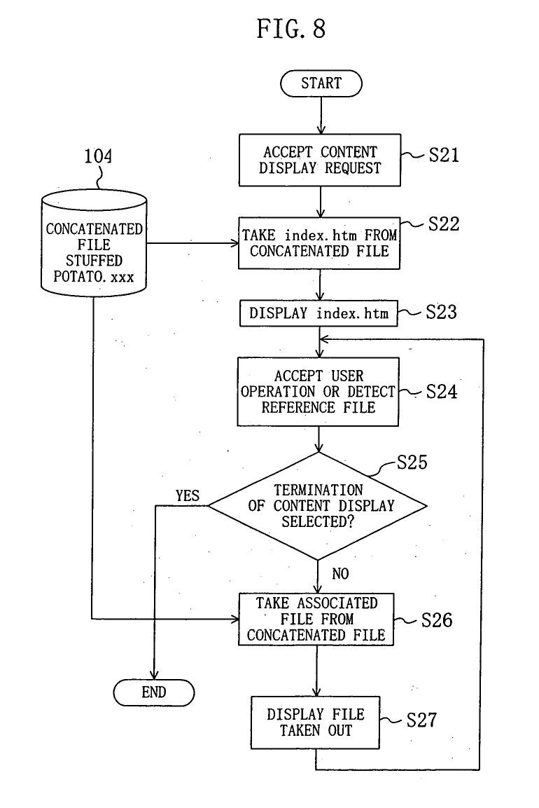

The concatenated file thus created and stored in the storage section 101a of the server 101 is downloaded via the communication network 102 by, for example, an instruction operation of a user to the terminal 103, and recorded on the semiconductor memory card 104 inserted into the semiconductor memory writer 103b in a writable state. Then, the semiconductor memory card 104 is taken out from the semiconductor memory writer 103b and inserted into the semiconductor memory reader 112 of the microwave oven 105 so that displays as shown in FIG. 4 are produced through a display process performed by, for example, a browser program. Hereinafter, the display process based on the concatenated file will be described with reference to a flowchart shown in FIG. 8. In the following display process, processes in (Steps S22 and S26) are particularly different from the normal processes of reading files. The other processes can adopt the same processes as in the case of display based on normal files, basically.

(Step S21) First, a request to display a recipe by user operation of the microwave oven 105 is accepted. Specifically, selection from a list of recipes recorded on the semiconductor memory card 104 or the like is accepted.

(Step S22) Then, if “stuffed potato” is selected, for example, the contents of the file index.htm for producing the first display D1 in FIG. 4 is taken out from the concatenated file “stuffed potato” recorded on the semiconductor memory card 104. More specifically, firstly, the header in the concatenated file (in FIG. 5) is referred to, and information (offset) representing the beginning of the contents of the subconcatenation file whose file name is index.htm is taken out from the concatenated file. Then, the contents of the subconcatenation file from the offset position to the position corresponding to the end of the file index.htm are read out. By thus referring to the header in reading out the contents of the subconcatenation file, it is unnecessary to read the entire concatenated file. Accordingly, it is easy to display contents even in an apparatus with a small available memory capacity such as the microwave oven 105 and a cellular phone.

The contents of the subconcatenation file that have been read out in the manner as described above are not stored as a normal file in a file system as in the case of using a general compressing and expanding program, but passed to a process for a display at next (Step S23). This allows the process for the display to be performed quickly. Since the subconcatenation file is not stored as a normal file, the display process and like processes are performed easily even in the case of application to apparatus with greater constraints of resources than apparatus such as a personal computer equipped with an auxiliary storage device having a sufficiently large capacity, a case where the concatenated file is written into a read-only memory (ROM), or a case where the subconcatenation file taken out from the concatenated file cannot be stored because the semiconductor memory card 104 does not have enough available space, for example.

The function of taking the contents of a subconcatenation file from the concatenated file as described above may be provided to a browser program itself or to a plug-in of the browser, or may be implemented as an extension function of a file system. If this function is provided to the plug-in or the file system, data is transmitted from, for example, the plug-in to the browser as in the case of reading a normal file, so that the same display process is performed by the browser for both the concatenated file and the normal file. Accordingly, a general-purpose browser program can be performed easily, for example.

(Step S23) The display D1 in FIG. 4 is produced based on the contents of the file index.htm which has been transmitted in (Step S22).

(Step S24) A user operation of directing a screen (page) to be displayed next or a user operation of terminating display is accepted, or a file (e.g., the image file f1.jpg to be linked in the case of the file index.htm) to be referred to by the file which is being displayed is detected.

(Step S25) It is determined whether the operation of terminating display is performed or not. If this operation is performed, the process is terminated, whereas if this operation is not performed, the process proceeds to (Step S26).

(Step S26) The contents of a file associated with the operation or detection in (Step S24), e.g., the file f2.htm for the next display D2 or the image file f1.jpg shown in the display D1, is taken out from the concatenated file in the same manner as in (Step S22) and passed to a process for the next display.

(Step S27) A display is produced based on the contents of the file which has been passed, in the same manner as in (Step 23). Thereafter, the process returns to (Step 24), and (Steps S24 through S27) are repeated until the operation of terminating display is performed.

In a case where a plurality of files are distributed and recorded on a recording medium by a given capacity unit such as a cluster unit, a plurality of files are united and dealt with as one concatenated file in the above manner, so that it is possible to prevent each of the files from occupying a cluster. Accordingly, the capacity of the recording medium is effectively used. In addition, a plurality of files constituting contents having a group of subjects are treated as a concatenated file as described above, so that downloading, removal and other operations are easily managed.

In the above example, files for displaying one recipe (a group of contents) constitute one concatenated file. However, the present invention is not limited to this, and various combinations of files may constitute (a) concatenated file(s). For example, files for displaying a plurality of recipes may constitute one concatenated file, or files for displaying one recipe may be divided into a plurality of groups so that each of the groups constitutes a concatenated file. In a case where combinations of files constitute a plurality of concatenated files as described above, a file combination selecting section for selecting a group of files to be combined may be provided to select files to be combined in consideration of a cluster size of a recording medium, for example. Specifically, in a case where the sizes of two files for displaying a first recipe are 5 Kbytes and 4 Kbytes, respectively, the sizes of two files for displaying a second recipe are 4 Kbytes and 3-Kbytes, respectively, and the cluster size is 8 Kbytes, for example, if the 5-Kbyte file and the 3-Kbyte file are combined and the two 4-Kbyte files are combined such that the size of each of the two resultant concatenated files is less than or equal to an integral multiple of the cluster size, the contents of all the files are recorded with a minimum number of clusters. In a case where the size of clusters, for example, differs according to a recording medium, means for detecting the size of clusters which are actually used or, if there is a relation between the total capacity of the recording medium and the sizes of the clusters, means for detecting the total capacity may be provided so that the selection is made in accordance with a result of the detection.

In the above example, the concatenated file is created by the concatenation processing section 101b provided in the server 101. However, the present invention is not limited to this, and a plurality of files downloaded to the terminal 103 as normal files may be formed into a concatenated file by the terminal 103. In such a case, a file combination selecting section may be provided in the semiconductor memory writer 103b as described above, for example, to determine a combination of files to be stored in a concatenated file, generate a concatenated file for storing these files, and write the concatenated file into the semiconductor memory card 104 such that the concatenated file is written into the semiconductor memory card 104 most effectively in consideration of the cluster size of the semiconductor memory card 104.

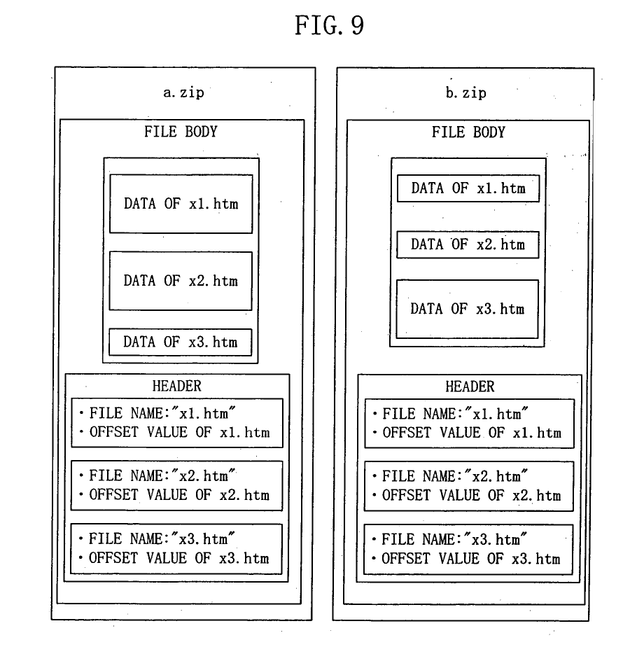

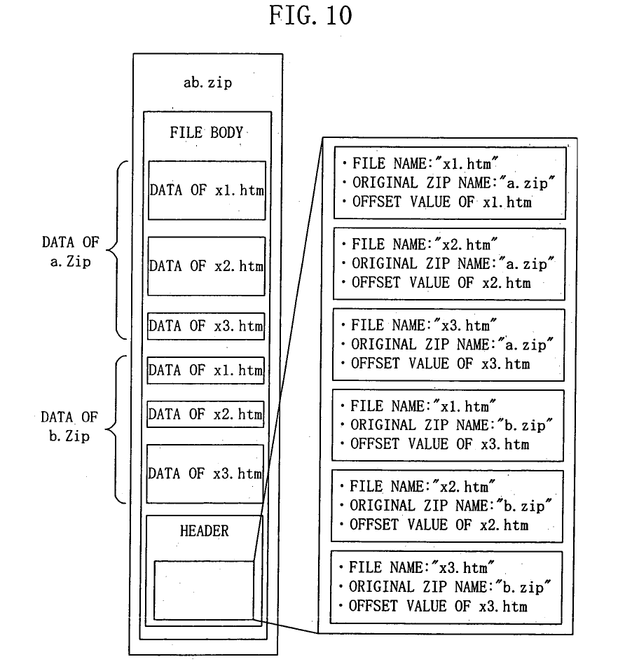

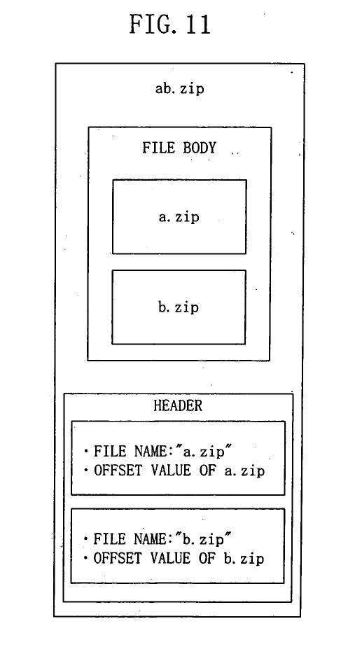

In addition, a multiplex concatenated file may be configured in accordance with, for example, the cluster size by further concatenating a plurality of concatenated files downloaded from the server 101. Specifically, a concatenated file ab.zip as shown in FIG. 10 may be configured based on two concatenated files a.zip and b.zip as shown in FIG. 9, for example. In such a case, if the header of the multiplex concatenated file contains, for example, file names of the original concatenated files as shown in FIG. 10, the contents of an appropriate file can be taken out easily even in a case where normal files in the original concatenated files a.zip and b.zip have the same file name. Alternatively, the concatenated files a.zip and b.zip may be concatenated as normal files, as shown in FIG. 11. In such a case, the header of the file ab.zip may be referred to first, and the header of the original concatenated file a.zip or b.zip or the header of these files may be taken out next, and then a target file in the files a.zip and b.zip may be taken out based on the header which has been taken out.

In a case where a file stored in a downloaded concatenated file refers to (is linked to) a file stored in another concatenated file, the download device 103a may also download the concatenated file storing the file which is referred to.

In a case where normal files and folders are recorded, being mixed with a concatenated file as shown in FIG. 6, a browser, for example, may have a function of searching the normal folders for a file which is directed to be read out first, and then, if the file is not found in the normal folders, searching files stored in the concatenated file. Alternatively, the location or the order of the search may be directed by specifying a path.

The name of a file to be read out first may be set in the header of a concatenated file. Then, in a case where only the name of the concatenated file is specified in reading and the name of the file to be read out is not indicated explicitly, it is possible to read a file to be read out if the name of the file is specified in the header, or to read the file index.htm first if the file name is not specified.

In the above example, an apparatus for displaying contents has been described, taking, as an example, the microwave oven serving as a cooking apparatus. However, the apparatus may be other cooking apparatuses such as an oven. Alternatively, the contents may be displayed by a cellular phone, a personal data assistant, a so-called set-top box or the like, or may be displayed by the terminal 103 itself.

In the above example, files to be concatenated are document files showing a cooking procedure and the like and image files. However, the present invention is not limited to this, and control data files including data regarding, for example, control of equipment such as temperature setting or heating power of a microwave oven may be stored in the same manner. However, files containing not only cooking data but also other image data, audio data, document data and the like may be dealt with as the contents.

In the above example, the contents as described above are distributed via a network. However, the present invention is not limited to this, and is applicable in a case where data is distributed with a concatenated file recorded on a recording medium and is, for example, displayed by the microwave oven 105 as described above or the like.

### INDUSTRIAL APPLICABILITY

As described above, according to the present invention, contents composed of a plurality of files can be treated as one file, so that the contents are utilized easily. In addition, if the contents are stored on a recording medium, the capacity of the recording medium is used effectively.

1. A content providing method, comprising the steps of:
creating a concatenated file by concatenating a plurality of files constituting contents;
creating a list including information representing the beginnings of the respective files in the concatenated file and adding the list to the concatenated file;
storing the concatenated file to which the list has been added in a server; and
downloading the concatenated file from the server via a communication network and storing the downloaded concatenated file on a recording medium.

2. The content providing method of claim 1, characterized in that the concatenated file is stored on the recording medium by a given recording capacity unit.

3. The content providing method of claim 1, characterized by including the step of reading and displaying a file to be displayed in the concatenated file, based on the list.

4. The content providing method of claim 1, characterized in that the contents are information regarding cooking.

5. A content providing method, comprising the steps of:
creating a concatenated file by concatenating a plurality of files constituting contents;
creating a list including information representing the beginnings of the respective files in the concatenated file, and adding the list to the concatenated file;
storing the concatenated file to which the list has been added in a server; and
downloading the concatenated file from the server via a communication network, and displaying the downloaded concatenated file.

6. A content reading apparatus for reading a file from a concatenated file in which a plurality of files are concatenated,
wherein the plurality of files constitute contents,
the concatenated file is provided with a list including information representing the beginnings of the respective files in the concatenated file, and
the beginning of a file to be read out is obtained by referring to the list, and the file to be read out is read out from the beginning.

7. The content reading apparatus of claim 6, characterized in that the file which has been read out is displayed on a display section.

8. The content information reading apparatus of claim 6, characterized in that the contents are information regarding cooking.

9. A cooking-related apparatus for reading a concatenated file which is stored on a recording medium and in which a plurality of files constituting contents as information representing a cooking procedure are concatenated,
wherein the concatenated file is provided with a list including information representing the beginnings of the respective files in the concatenated file, and
the beginning of a file to be read out is obtained by referring to the list, and the file to be read out is read out from the beginning.

10. The cooking-related apparatus of claim 9, characterized in that the file which has been read out is displayed on a display section.

11. The cooking-related apparatus of claim 9, characterized in that the contents includes a file representing control information for controlling operation of the cooking-related apparatus, and
the operation is controlled based on the control information.

12. A content recording apparatus for recording, on a recording medium, contents downloaded from a server,
wherein the contents are recorded on the recording medium by a given recording capacity unit, and
a plurality of files constituting the contents are concatenated to create a concatenated file composed of combinations of the files such that each of the combinations has a size which is less than or equal to an integral multiple of the recording capacity unit and has a minimum difference from the integral multiple of the recording capacity unit.

13. The content recording apparatus of claim 12, characterized in that the recording capacity unit in the recording medium is detected, and the concatenated file is created based on a result of the detection.

14. A content recording apparatus for recording, on a recording medium, contents downloaded from a server,
wherein the contents are recorded on the recording medium by a given recording capacity unit, and
a multiplex concatenated file is created by performing a multiplexing concatenation on a plurality of concatenated files which has been downloaded from the server and in which a plurality of files constituting the contents are concatenated, and the multiplex concatenated file is recorded on the recording medium.

15. The content recording apparatus of claim 14, characterized in that in performing the multiplexing concatenation, a list which is added to each of the concatenated files and which includes information representing the beginnings of the respective files in the concatenated files is removed, and
a list including information representing the beginnings of the respective files and also representing a correlation between the files and the concatenated files in the multiplex concatenated file is created, and the list is added to the multiplex concatenated file, so that the multiplex concatenated file is created and recorded on the recording medium.

16. The content recording apparatus of claim 14, characterized in that in performing the multiplexing concatenation, the multiplexing concatenation is performed with a list including information representing the beginnings of the respective files in each of the concatenated files added to each of the concatenated files, and
a list including information representing the beginnings of the respective concatenated files before the multiplexing concatenation in the multiplex concatenated file is created and added to the multiplex concatenated file, so that the multiplex concatenated file is created and recorded on the recording medium.

17. A content reading apparatus for reading a file recorded by the content recording apparatus of claim 14, wherein the beginning of a file before the first concatenation is performed included in the multiplex concatenated file is obtained, so that the file before the first concatenation is performed is read out.

18. A content reading apparatus for reading a file recorded by the content recording apparatus of claim 15,
wherein the beginning of a file before the first concatenation is performed included in the multiplex concatenated file is obtained by referring to the list, so that the file before the first concatenation is performed is read out.

19. A content reading apparatus for reading a file recorded by the content recording apparatus of claim 16, wherein the beginning of a file before the first concatenation is performed included in the multiplex concatenated file is obtained by referring to the list, so that the file before the first concatenation is performed is read out.
